(19) United States
(12) Patent Application Publication
(10) Pub. No.: US 2017/0108102 A1
(43) Pub. Date: Apr. 20, 2017

(54) ONE WAY CLUTCH

(71) Applicant: Caterpillar Inc., Peoria, IL (US)

(72) Inventors: Edward De Jesús Rivera, Peoria, IL (US); Paul D. Cashatt, Edwards, IL (US)

(73) Assignee: Caterpillar Inc., Peoria, IL (US)

(21) Appl. No.: 14/883,665

(22) Filed: Oct. 15, 2015

(51) Int. Cl. F16H 45/02; F16D 41/12

(52) U.S. Cl. CPC F16H 45/02; F16D 41/12

(57) ABSTRACT

A one way clutch includes a first ring member and a second ring member located concentrically with respect to the first ring member. The one way clutch includes at least one engaging assembly disposed between the first ring member and the second ring member. The engaging assembly includes at least one cam member positioned in at least one of the first ring member and the second ring member. The one way clutch further includes at least one biasing member that is contacted to a corresponding cam member in a radial direction. Further, the biasing member is adapted to apply a positive biasing force in the radial direction on the corresponding cam member. The cam member includes a bottom curved portion that engages with the first groove. The cam member includes a top curved portion that extends substantially tangentially from the bottom curved portion. The cam member further includes a nose portion positioned below the top curved portion, in contact with the biasing member.

### TECHNICAL FIELD

The present disclosure relates to a torque converter. More particularly, the present disclosure relates to a torque converter having a one way clutch assembly present therein.

### BACKGROUND

Earth moving machines have long been known to employ torque converters to co-operate with their engines. Torque converters typically contain clutches having several sets of clutch plates and/or friction plates. However, the current design of the clutches is such that the one way clutches are sensitive to variations in speed.

A torque converter is generally a hydrodynamic fluid coupling that transfers rotational torque from a prime mover to a driven load such as a transmission. The torque converter typically includes an impeller, a turbine, and a stator. The torque converter multiplies the torque from the prime mover and transfers the torque to the transmission. In an example, as described in U.S. Pat. No. 6,186,298, a one-way clutch having a lock-up function, comprises an outer race, an inner race radially spaced apart from the outer race and disposed within the outer race concentrically for relative rotation, a cam surface provided on an inner peripheral surface of the outer race or an outer peripheral surface of the inner race, a track surface provided on the outer peripheral surface of the inner race or the inner peripheral surface of the outer race in a confronting relationship to the cam surface, a plurality of roller members disposed between the outer race and the inner race and adapted to transmit torque between the outer race and the inner race, springs for biasing the roller members toward one circumferential direction, a side plate for holding the roller members and the springs with predetermined intervals along a circumferential direction, and a control member for acting on the roller members to effect lock-up control, and wherein the control member controls the one-way clutch to lock up the one-way clutch in both directions or one direction by urging the roller members radially against the outer peripheral surface of the inner race or the inner peripheral surface of the outer race to frictionally engage the former with the latter or by releasing the roller members.

### SUMMARY OF THE DISCLOSURE

In one aspect of the present disclosure a one way clutch includes a first ring member and a second ring member located concentrically with respect to the first ring member. The one way clutch includes at least one engaging assembly disposed between the first ring member and the second ring member. The engaging assembly includes at least one cam member positioned in at least one of the first ring member and the second ring member. The one way clutch further includes at least one biasing member that is contacted to a corresponding cam member in a radial direction. Further, the biasing member is adapted to apply a positive biasing force on the corresponding cam member in the radial direction.

In another aspect of the present disclosure a method of operating a one way clutch that includes a first ring member, a second ring member and at least one engaging assembly. The method includes applying, through the biasing member, a positive force on the cam member in a radial direction, engaging the engaging assembly with one of the first ring member and the second ring member and restricting a relative rotation of the first ring member and the second ring member.

In yet another aspect of the present disclosure a torque converter includes a turbine rotatably coupled to a torque converter output to rotate therewith and an impeller that is hydraulically coupled to the turbine. The torque converter includes a stator housed on a stationary member, within the turbine and the impeller, wherein the stator comprises a plurality of vanes. The torque converter further includes a one way clutch coupled to the stator. The one way clutch includes a first ring member and a second ring member located concentrically with respect to the first ring member. The second ring member adapted to rotate relative to the first ring member. Further, one of the first ring member and the second ring member is coupled to the stator. The one way clutch includes at least one engaging assembly disposed between the first ring member and the second ring member. Each of the engaging assembly includes at least one cam member positioned in at least one of the first ring member and the second ring member. The engaging assembly further includes at least one biasing member contacted to a corresponding cam member in the radial direction. Further, the biasing member is adapted to apply a positive biasing force on the corresponding cam member to engage the cam member in the radial direction with other of the first ring member and the second ring member, thereby selectively restricting relative rotation of the first ring member and the second ring member.

Other features and aspects of this disclosure will be apparent from the following description and the accompanying drawings.

### BRIEF DESCRIPTION OF THE DRAWINGS

FIG. 1 is a cross sectional view of a torque converter, according to an embodiment of the present disclosure;

FIG. 2 is a sectional side view of the torque converter, according to an embodiment of the present disclosure;

FIG. 3 is a cross sectional view of the one way clutch according to the embodiment of the present disclosure;

FIG. 4 is a cross sectional view of an engaging assembly, according to the embodiment of the present disclosure;

FIG. 5 is a cross sectional view of the one way clutch according to another embodiment of the present disclosure; and

FIG. 6 is a method flow chart of the operation of the one way clutch according to an embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

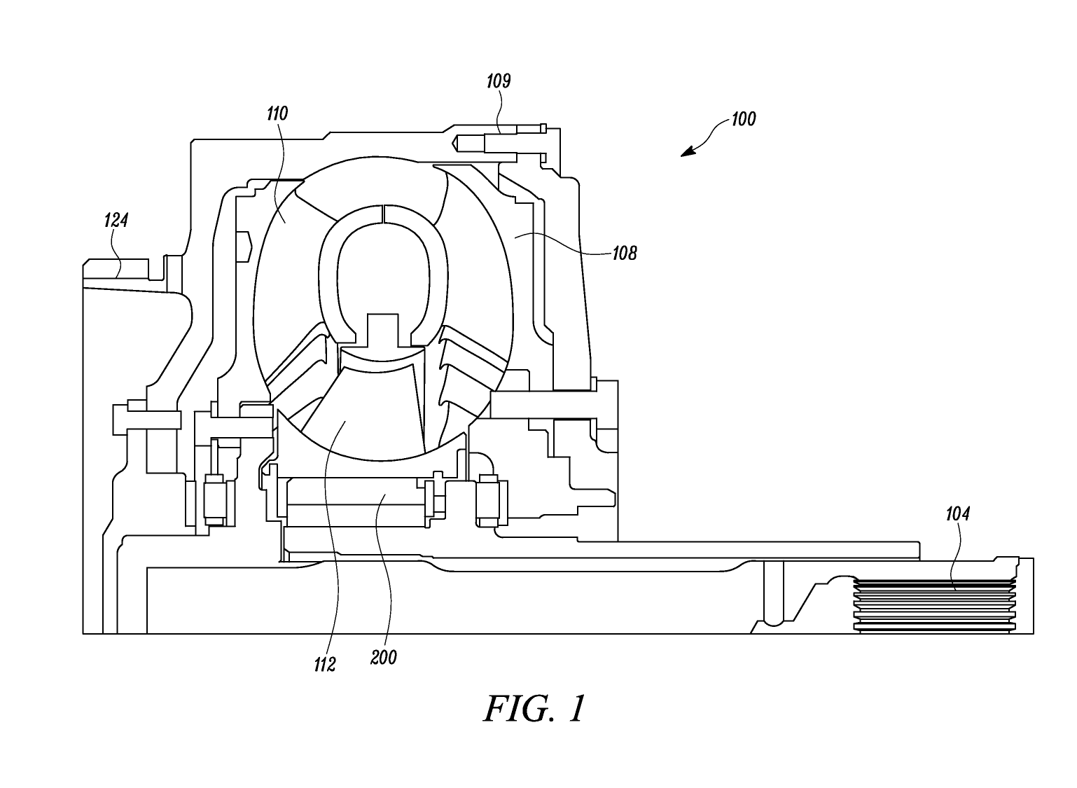

FIG. 1 illustrates a torque converter 100, in accordance with embodiments of the present disclosure. The torque converter 100 disclosed herein may be used in mobile machines for e.g., wheeled vehicles that are typically employed in various applications including, but not limited to, mining, quarrying, road construction, site preparation, etc. The torque converter 100 includes a prime mover input 124 and a torque converter output 104. The prime mover input 124 is configured to receive the input torque from a prime mover (not shown). The prime mover can be any source of power such as an internal combustion engine, electric motor and the like. The torque converter output 104 is configured to receive power from the torque converter 100. The power from the torque converter output 104 may drive a load, or a transmission system of a machine (not shown).

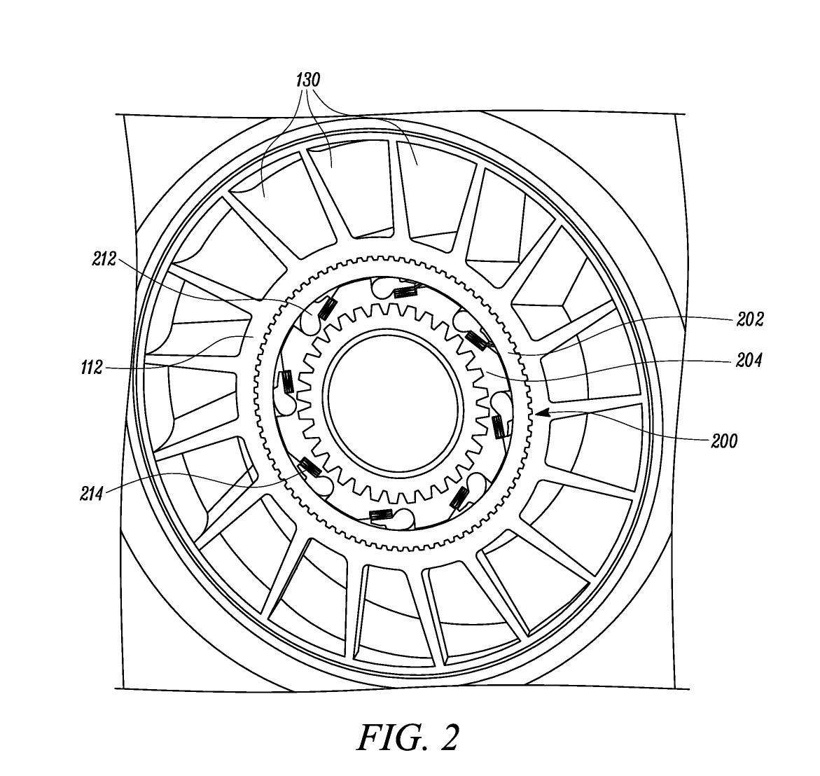

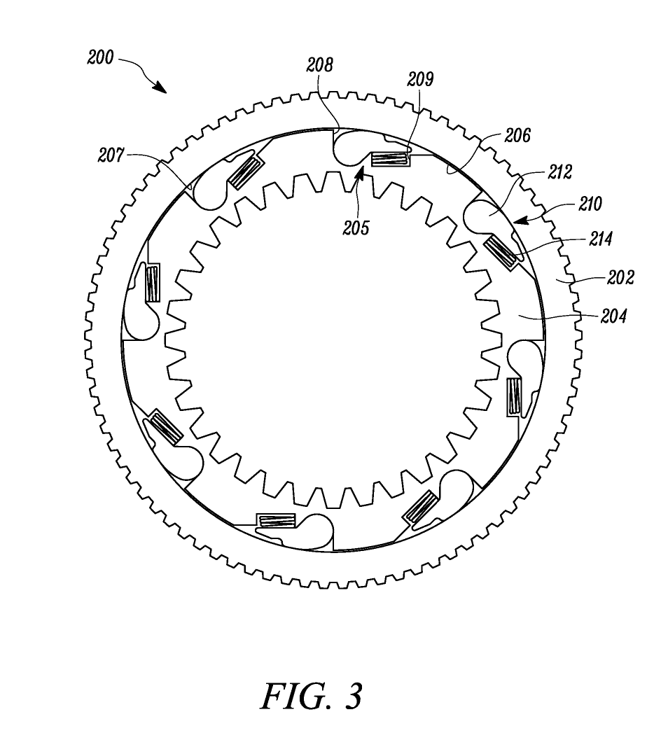

The torque converter 100 also includes an impeller 108, a turbine 110, a stator 112, and a one way clutch 200. The turbine 110 is rotatably coupled to the torque convertor output 104. The impeller 108 is rotatably coupled to the prime mover input 124 by means of a fastening member 109. The impeller 108 may rotate in response to the input torque from the prime mover. The stator 112 is located between the impeller 108 and the turbine 110. The stator 112 comprises a plurality of vanes 130 (shown in FIG. 2). Referring to FIGS. 2 and 3, the one way clutch 200 of the torque converter 100 is coupled to the stator 112. The one way clutch 200 includes a first ring member 202 and a second ring member 204. The second ring member 204 is located concentrically with respect to the first ring member 202. The second ring member 204 is adapted to rotate relative to the first ring member 202. It may be contemplated that, one of the first and second ring members 202, 204 is coupled to the stator 112.

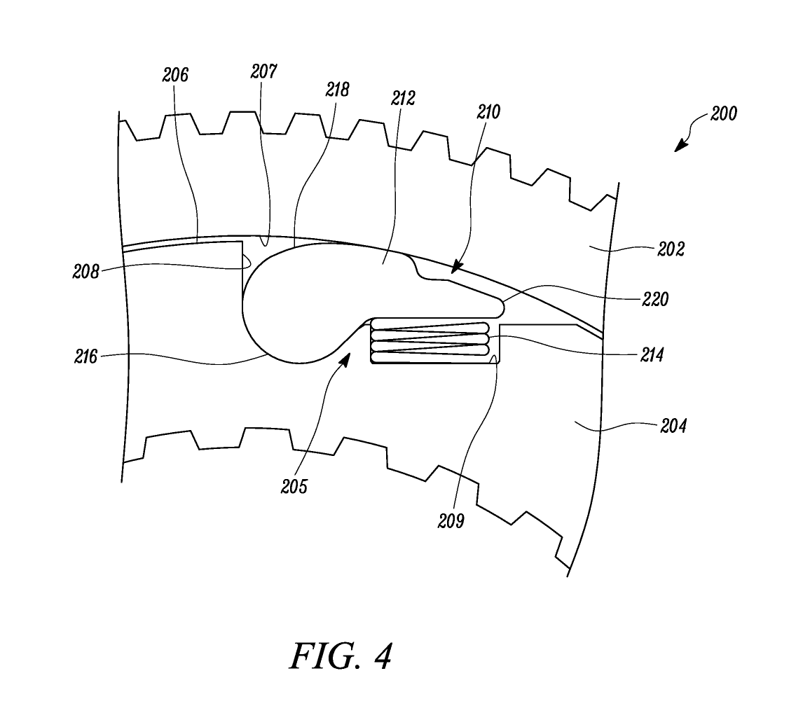

FIGS. 3 and 4 are cross sectional views of the one way clutch 200 according to the embodiment of the present disclosure. The one way clutch 200 includes at least one engaging assembly 210 disposed between the first ring member 202 and the second ring member 204. Each of the engaging assembly 210 includes at least one cam member 212 and one biasing member 214. The cam member 212 is positioned in at least one of the first ring member 202 and the second ring member 204.

The biasing member 214 of the engaging assembly 210 is contacted to a corresponding cam member 212 in a radial direction, as shown. The biasing member 214 can be a spring, pin, metal strip or any other objects that are known in the art. In an example, the engaging assembly 210 is housed on an outer peripheral face 206 of the second ring member 204. The outer peripheral face 206 includes a grooved portion 205. The grooved portion 205 includes a first groove 208 and a second groove 209. It can be contemplated that the engaging assembly 210 may be housed on an inner peripheral face 207 of the first ring member 202. The first and second grooves 208, 209 are configured to house the engaging assembly 210.

Referring to FIG. 4, the cam member 212 includes a bottom curved portion 216, a top curved portion 218 and a nose portion 220. The bottom curved portion 216 slidably engages with the first groove 208. The top curved portion 218 extends substantially tangentially from the bottom curved portion 216. The nose portion 220 is shaped such that is extends away from the top curved portion 218. The biasing member 214 is positioned between the nose portion 220 and the second groove 209. As shown in FIG. 4, the biasing member 214 remains contacted to the nose portion 220 on one end and to the second groove 209 on the other end. The biasing member 214 is adapted to apply a positive biasing force on the corresponding cam member 212 in a radial direction, as shown. The positive biasing force of the biasing member 214 engages the cam member 212 with the first ring member 202. Further, the engaging assembly 210 selectively restricts relative rotation between the first ring member 202 and the second ring member 204.

The first ring member 202 may rotate relative to the second ring member 204 either in a first direction, e.g., clockwise direction or in a direction opposite to the first direction, e.g., counter clockwise. Referring to the embodiment as shown in FIG. 3, the engaging assembly 210 is housed such that the nose portion 220 points towards the first direction. The top curved portion 218 of the cam member 212 is slidably coupled to the inner peripheral face 207 of the first ring member 202.

When the first ring member 202 rotates in a direction opposite to the first direction, i.e., in the counter clockwise direction, the biasing member 214 applies a positive biasing force on the nose portion 220 in the radial direction. The bottom curved portion 216 slidably turns along the first groove 208 such that the cam member 212 moves outwards in the radial direction. Further, the cam member 212 applies the positive biasing force via the top curved portion 218 on the inner peripheral face 207 of the first ring member 202.

The positive biasing force restricts the rotation of the first ring member 202 in the direction opposite to the first direction. When the first ring member 202 rotates in the direction opposite to the first direction, the cam member 212 turns about the first groove 208 and exerts an opposing force on the biasing member 214. Thus, allowing motion opposite to the first direction. It may be contemplated that the arrangement of the engaging assembly 210 may allow the motion of the second ring member 204 in the direction opposite to the first direction.

In operation, the prime mover input 124 can receive the input torque from the prime mover. The impeller 108 can be configured to rotate in response to the prime mover input 124. The rotation of the impeller 108 may generate a hydrodynamic fluid coupling within the torque converter 100, which rotates the turbine 110. The stator 112 may be interposed between the impeller 108 and the turbine 110, and can positivity and efficiently alter the fluid flow between the turbine 110 and the impeller 108. The stator 112 may freely rotate with the torque converter 100. However, the stator 112 is configured to rotate in the first direction, and is prevented from rotating in the second direction by the one way clutch 200.

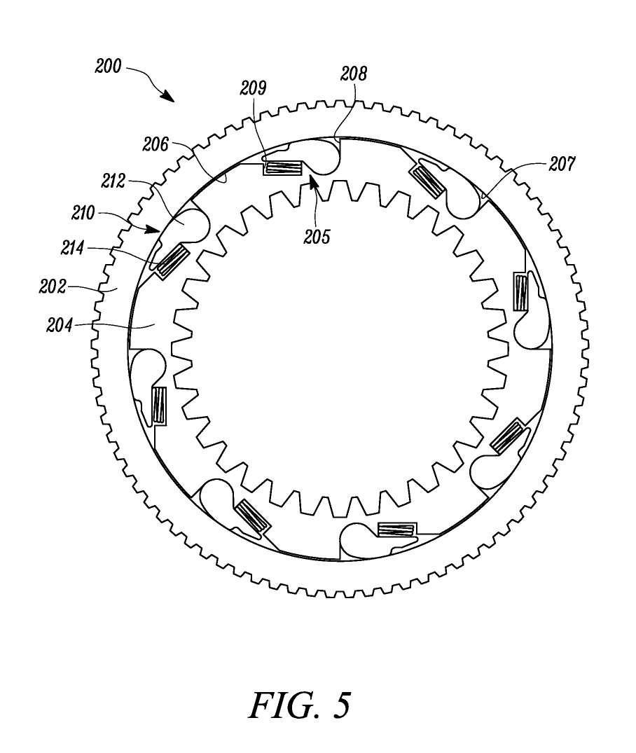

Referring to FIG. 5, the engaging assembly 210 is housed such that the nose portion 220 points towards the direction opposite to the first direction. The arrangement of the engaging assembly 210 allows the motion of the first ring member 202 in the direction opposite to the first direction relative to the second ring member 204. Further, the arrangement of the engaging assembly 210 shown in FIG. 5 restricts the motion of the first ring member 202 in the first direction relative to the second ring member 204. It can also be contemplated that the arrangement of the engaging assembly 210 may allow the motion of the second ring member 204 in the first direction relative to the first ring member 202.

In an example, with the arrangement of the engaging assembly 210 as shown in FIG. 5, the first ring member 202 can rotate relative to the second ring member 204 in the direction opposite to the first direction. The first ring member 202 may drive the second ring member 204 when rotated in the first direction. Similarly, the second ring member 204 may drive the first ring member 202 if rotated in the direction opposite to the first direction. In such condition a driven member may overrun a driving member if required. In another example, the present arrangement of the engaging assembly 210 may allow the rotation of the first ring member 202 in the direction opposite to the first direction and the second ring member 204 in the first direction, simultaneously.

### INDUSTRIAL APPLICABILITY

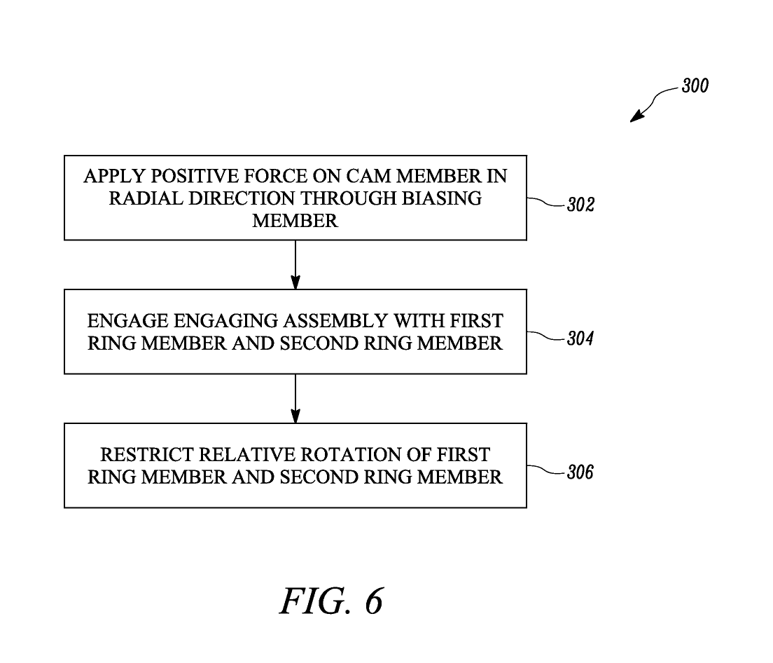

The one way clutch 200 disclosed herein includes components that are less complicated and are more efficient in transmitting torque from the turbine 110 to the impeller 108. FIG. 6 is a flowchart for a method 300 of operating the one way clutch 200. At step 302 a positive force is applied through the biasing member 214 on the cam member 212 in a radial direction. At step 304, the engaging assembly 210 is engaged with one of the first ring member 202 and the second ring member 204. At step 304, a relative rotation of the first ring member 202 and the second ring member 204 is restricted. The arrangement of the engaging assembly 210 including the cam member 212 and the biasing member 214 allows relative motion between the first ring member 202 and the second ring member 204. The first ring member 202 and the second ring member 204 can have relative motion such that one of them can be stationary and the other member can rotate. Further, either of the first and second ring members 202, 204 may be locked with respect to each other such that either of the ring members may overrun at necessary conditions. This may allow the turbine 110 to overrun with respect to the stator 112 at high speed ratios or multiply the torque while running at low speed ratios. The cam member 212 of the engaging assembly 210 is slidably coupled to the first and the second ring members 202, 204 that minimize area of contact between the first and the second ring members 202, 204. The minimum contact between the first and the second ring members 202, 204 ensures smooth operation.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A one way clutch comprising:
a first ring member;
a second ring member located concentrically with respect to the first ring member, the second ring member adapted to rotate relative to the first ring member; and
at least one engaging assembly disposed between the first ring member and the second ring member, each engaging assembly comprising;
at least one cam member positioned in at least one of the first ring member and the second ring member, and
at least one biasing member contacted to a corresponding cam member in a radial direction thereof,
wherein, the biasing member is adapted to apply a positive biasing force on the corresponding cam member in the radial direction to engage the cam member with other of the first ring member and the second ring member, thereby selectively restricting relative rotation of the first ring member and the second ring member.

2. The one way clutch of claim 1, wherein the engaging assembly is configured to engage with the first ring member to restrict rotation thereof in one of a first rotational direction and a direction opposite to the first rotational direction, when the second ring member is stationary.

3. The one way clutch of claim 2, wherein the engaging assembly is configured to engage with the second ring member to restrict rotation thereof in one of the first rotational direction and the direction opposite to the first rotational direction, when the first ring member is stationary.

4. The one way clutch of claim 3, wherein the engaging assembly is configured to engage with the first ring member to restrict rotation thereof in the first rotational direction when the second ring member is rotating in the direction opposite to the first rotational direction.

5. The one way clutch of claim 4, wherein the engaging assembly is configured to engage with the second ring member to restrict rotation thereof in the first rotational direction when the first ring member is rotating in the direction opposite to the first rotational direction.

6. The one way clutch of claim 5, wherein the engaging assembly is configured to engage with the first ring member to restrict rotation thereof in the first rotational direction when the second ring member is rotating in the first rotational direction.

7. The one way clutch of claim 6, wherein the engaging assembly is configured to engage with the second ring member to restrict rotation thereof in the first rotational direction when the first ring member is rotating in the first rotational direction.

8. The one way clutch of claim 6, wherein one of the one of the first ring member and the second ring member comprising;
at least one grooved portion formed on a peripheral face thereof, the grooved portion comprising a first groove for housing the cam member and a second groove for housing the biasing member.

9. The one way clutch of claim 4, wherein the cam member comprising;
a bottom curved portion engaged with the first groove,
a top curved portion extending substantially tangentially from the bottom curved portion, and
a nose portion positioned below the top curved portion and in contact with the biasing member.

10. The one way clutch of claim 9, wherein the biasing member is a spring configured to apply constant biasing force on the nose portion of the cam member.

11. The one way clutch of claim 10, wherein the top curved portion of the cam member engages with one of the first ring member and the second ring member, such that the rotation of one of the first ring member and the second ring member with respect to the other of the first ring member and the second ring member, in a direction of the top curved portion extension with respect to the bottom curved portion, is restricted.

12. A method of operating a one way clutch comprising a first ring member, a second ring member, at least one engaging assembly, the method comprising,
applying, through the biasing member, a positive force on the cam member in a radial direction;
engaging the engaging assembly with one of the first ring member and the second ring member; and
restricting a relative rotation of the first ring member and the second ring member.

13. The method of claim 12 comprising engaging the engaging assembly with the first ring member to restrict rotation thereof, in one of a first rotational direction and a direction opposite to the first rotational direction, when the second ring member is stationary.

14. The method of claim 13 comprising engaging the engaging assembly with the second ring member to restrict rotation thereof, in one of a first rotational direction and a direction opposite to the first rotational direction, when the first ring member is stationary.

15. A torque converter comprising:
a turbine rotatably coupled to a torque converter output to rotate therewith;
an impeller hydraulically coupled to the turbine;
a stator housed on a stationary member, within the turbine and the impeller, wherein the stator comprises a plurality of vanes; and
a one way clutch coupled to the stator, the one way clutch comprising:
a first ring member,
a second ring member located concentrically with respect to the first ring member, the second ring member adapted to rotate relative to the first ring member, wherein one of the first ring member and the second ring member is coupled to the stator, and
at least one engaging assembly disposed between the first ring member and the second ring member, each engaging assembly comprising,
at least one cam member positioned in at least one of the first ring member and the second ring member, and
at least one biasing member contacted to a corresponding cam member,
wherein, the biasing member is adapted to apply a positive biasing force on the corresponding cam member to engage the cam member with other of the first ring member and the second ring member, thereby selectively restricting relative rotation of the first ring member and the second ring member.

16. The torque converter of claim 15, wherein the engaging assembly is configured to engage with the first ring member to restrict rotation thereof in one of a first rotational direction and a direction opposite to the first rotational direction, when the second ring member is stationary.

17. The torque converter of claim 16, wherein the engaging assembly is configured to engage with the second ring member to restrict rotation thereof in one of the first rotational direction and the direction opposite to the first rotational direction, when the first ring member is stationary.

18. The torque converter of claim 17, wherein the engaging assembly is configured to engage with the first ring member to restrict rotation thereof in the first rotational direction when the second ring member is rotating in the direction opposite to the first rotational direction.

19. The torque converter of claim 18, wherein the engaging assembly is configured to engage with the second ring member to restrict rotation thereof in the first rotational direction when the first ring member is rotating in the direction opposite to the first rotational direction.

20. The torque converter of claim 17, wherein the engaging assembly is configured to engage with the first ring member to restrict rotation thereof in the first rotational direction when the second ring member is rotating in the first rotational direction.
